(19) United States
(12) Patent Application Publication
(10) Pub. No.: US 2017/0076300 A1
(43) Pub. Date: Mar. 16, 2017

(54) CITY DATA MAREKTPLACE

(71) Applicant: PHILIPS LIGHTING HOLDING B.V., Eindhoven (NL)

(72) Inventors: DAVE ALBERTO TAVARES CAVALCANTI, EINDHOVEN (NL); DAN JIANG, EINDHOVEN (NL); TAIMAI BrandÃo DE OLIVEIRA, EINDHOVEN (NL); YONG YANG, EINDHOVEN (NL)

(21) Appl. No.: 15/124,118

(22) PCT Filed: Feb. 26, 2015
(86) PCT No.: PCT/IB2015/051434

§ 371 Date: Sep. 7, 2016

Related U.S. Application Data
(60) Provisional application No. 61/951,824, filed on Mar. 12, 2014.

(51) Int. Cl. G06Q 30/02

(52) U.S. Cl. CPC G06Q 30/0201

(57) ABSTRACT

A method and corresponding system is disclosed that enables commercialization of data gathered in urban environments where multiple users and service provides can share and trade data. The invention enables data generated from multiple sources to be identified, and usage of the data tracked so that economic value can be assigned to the data as it is used. In addition, the invention provides users and service providers in an urban region to have access to valuable data to improve their specific services and applications, while providers of the data can receive compensation according to the usage of the data.

This application relates to the gathering and effective use of data obtained using various data collection networks. More particularly, the application relates to a method and a system for utilizing such networks to create a heterogeneous infrastructure for obtaining sensed information and for enabling commercialization of this data. In particular, the invention permits multiple users and service providers to share and trade/sell collected data.

Data collection and monitoring in an urban environment has a number of applications, from transportation, to industrial processes, to environment and healthcare. Wireless Sensor Networks (WSNs), to include Wireless Sensor and Actuator Networks (WSANs), currently exist and have been used for monitoring and control of physical systems in a number of applications, from transportation, to industrial processes, to environment and healthcare. Further, networked sensors embedded in the environment and infrastructure (e.g., in cars, roadway infrastructure, street lights, and buildings) essentially form a huge information infrastructure, also called Internet of Things (IoT).

Existing communication technologies, network infrastructure and protocols have enabled remote data collection and processing from virtually any type of sensors deployed across large areas. By way of example, U.S. Pat. No. 7,020,707; entitled “Method for Collecting and Processing Data Using Internetworked Wireless Integrated Network Sensors (WINS)” issued to Gelven et al. on Mar. 28, 2006 and hereby incorporated by reference; describes microsensor technology, low power signal processing, computation and wireless networking capabilities that enable deployment of embedded intelligent sensor and actuators systems in numerous applications.

In addition, mobile user devices have also become sources of data, and large scale mobile sensing has emerged recently as a new field for innovation (see e.g., Lane et al. “A Survey of Mobile Phone Sensing,” IEEE Communication Magazine, September 2010: 140-150). Mobile sensing devices are ubiquitous platforms to collect human and environmental information on various scales, from a person's specific activities to community wide information. Similarly, sensing and communication capabilities in cars or other personal devices (watches, activity monitors, etc.) open up new opportunities to collect information that are useful for optimization of many intelligent systems.

Recently, adding communication modules to outdoor lighting units to form outdoor lighting networks (OLNs) has opened up new opportunities to collect data on a large scale (e.g., city level). OLNs can provide many benefits including energy and maintenance savings through remote control and management of outdoor lighting. Light units are becoming more intelligent, and when combined with various sensor devices and communications capabilities, provide another platform to collect information, such as traffic, air quality, images and many other types of sensed data. An exemplary OLN system is described in co-pending patent application entitled “IMAGING SERVICE USING OUTDOOR LIGHTING NETWORKS” filed on Feb. 14, 2014 in the US Patent and Trademark Office and afforded Ser. No. 14/238,275, the contents of which are incorporated by reference, herein.

Typically, wireless sensors and actuators networks are deployed for a specific purpose, each with its own infrastructure to collect, process and present data to the target application and users. For instance, a city may maintain networks of traffic sensors, weather monitoring stations, outdoor lighting, power meters, surveillance cameras, etc. Each is usually a self-contained system including specific sensing technologies, communication protocols, and backend data storage/processing/visualization. There are solutions, mainly IT infrastructure and backend application frameworks, to integrate, visualize and process the data from multiple systems on a city management level (e.g. information management platforms from IBM, Cisco, Living PlaneIT, etc.). Similar concepts are also available for buildings (also called building management systems (BMS)).

In the future, the number of sensors, actuators and intelligent systems will increase and new usage models and applications should be enabled for the huge amount of data available besides integration, centralized access/visualization and data analytics-based system optimization enabled by existing technology. Addressing that need is one aspect of the present invention. By way of example, consider a city with several WSANs deployed to support intelligent systems (e.g. traffic management, surveillance, environment monitoring, lighting control, building automation, etc.). As previously described, information from such WSANs may be accessible through web-based platforms by city officials at different departments, government entities, or private businesses. Certain types of information may even be available to regular users/citizens through a web-service. For instance, users can subscribe to services that generate traffic alerts, news, weather, and many other types of notifications using RSS feeds, SMS, e-mail and social network services (e.g. Twitter, Facebook, etc). However the existing alert services are still specific to a particular subject, e.g. traffic, or weather, or news.

Collecting data across such heterogeneous infrastructures in an urban environment is discussed in co-pending patent application entitled “Personalized Sensing Information Service” filed on Feb. 7, 2013 in the US Patent and Trademark Office and afforded serial No. 61/762,095, the contents of which are incorporated by reference, herein.

This co-pending application further discusses methods to enable user devices (e.g. smart phones, tablets, desktop PCs, etc.) to use the data collected from such urban infrastructures to quantify/classify geographical areas and provide a visualization of the attractiveness of certain areas for new developments (e.g. new businesses, more parking spaces, more security, etc.).

The above described advances in sensing and communication technologies enable extensive data collection in a city environment. Such collected data may be used in a number of applications. For instance, traffic data may be used by a traffic management system to optimize traffic controls, as well as by a lighting management system to optimize lighting conditions on the roadway. In another example, data collected by sensors in cars can provide useful insights about roadway conditions to drivers, public safety/city maintenance teams as well as traffic management centers.

In addition, various crowdsourcing applications currently exist to collect data in the city environment. For instance, apps to report infrastructure problems around the city (e.g. broken lights, potholes, etc.) have been developed in several cities. In most cases, user (citizen) participation in the data collection process is voluntary. In order to encourage a greater number of users to participate, an incentive should be provided whereby some benefit is provided to the data sources (the “Owners” of the data). In some cases, users may receive a form of reward, for example, a compensation for reporting an infrastructure problem, such as a pothole or a broken streetlight. In most cases, however, the compensation is very specific to a certain application, e.g., reporting potholes. No mechanism currently exists that can apply for any type of data, across multiple domains. The current invention addresses virtually any type of data the city might collect and provides opportunities for users (to include private businesses) to access this data. Further, the current invention creates a means to compensate the provider of the data for its usage.

As cities release such data collection applications and install sensing, control and communication infrastructure (each having associated costs); it clearly would be advantageous to create revenue out of the collected data—not only to offset investments in the new technology involved, but also to promote economic development.

As described above, with current systems, data can be collected from heterogeneous devices, applications and sub-systems and can be shared with different users. In particular, such prior art systems enable the data to be accessed by multiple services through a common platform. That is, the prior-art addresses the technical aspects related to enabling the collection, aggregation, specification of requirements and access to data across systems with a unified platform. One remaining problem, however, is a system to enable the owners/sources of data to commercialize the data as it moves from system to system. For instance, an operator of a lighting network that collects traffic data (by traffic sensors installed in their own luminaires/poles) would like to be able to receive compensation when its data is used by another system, e.g., a traffic management system. Even when data is shared through secondary systems, e.g. the traffic management system shares the traffic data with a third system, the original provider of the data should be able to receive a fair market value for the usage of its data. Similar problems exist for users of crowdsourcing applications. That is, currently there is no solution for users/systems to directly sell their data to other users or systems and track the usage of the data at it moves from system to system in the city environment in order to receive compensation for initially providing this data.

While there exist prior art techniques to enable sale and re-sale of digital content in an Internet environment, the digital content is always acquired from a centralized service (e.g. content store) and the user/owner of the data is clearly identified through the user's account with the central service. Once such example of such prior art is U.S. Pub. No. 20060010075 A1 entitled “Technique for Facilitating Resale of Digital Content Over a Computer Network.”

In addition, there is also known centralized market systems for sharing and monetizing consumer data from independent users to companies who are interested in using the data to provide offer/promotions to the users. Such a system is described in U.S. Pub. No. 20110295694 A1 entitled “System and Method for an Individual Data Marketplace and Monetization.” However, different problems exist to enable data sharing across several sources and potential users in a smart city environment employing the various data collection mechanisms described above. Firstly, in such existing smart city environments the source data is not necessarily hosted in a central system. Rather, it can be generated from a large number of sources—from field devices (e.g. sensors, light poles, controllers etc) to mobile devices (tablets, smart phones, etc). Secondly, data from a number of sources may have different formats (e.g. unit, structure) and it may only make sense in the specific application context. Therefore, there is a need to clean and transform the data from one format to another in order to meet the needs of different applications. Thirdly, the data can be very granular, i.e., having a large number of data packets, which are independently generated, that provide information about a certain event. What is useful from a city services perspective is a combination of such data packets, e.g., the traffic activity in a certain roadway for a certain time period. Furthermore, identifying every data packet at its source must consider resource constraints in devices and communication infrastructure. Therefore, there is a need for a system and methods to group and efficiently identify the data from a large number of distributed sources. An additional problem is that the owner/source of the data may not be a single user, but a system that includes multiple devices (sensors, controllers, applications). By way of example, an outdoor lighting network may be the source/owner of data. The current invention enables a provider entity to be compensated for providing such data. By way of examples, this compensation may be in the form of money payment, receiving data in exchange from one or more other providers, and/or a credit against city provided services (e.g. utility bills, property taxes).

In summary, there is a need for a method and corresponding system that enables data generated from multiple sources to be identified, and permits usage of the data to be tracked so that economic value can be assigned to the data as it is used. In such a system users and service providers in an urban region have access to valuable data to improve their specific services and applications, while providers of the data receive compensation according to the usage of the data. By providing such monetary incentives, the invention thereby enables new data-driven applications and services in city/urban environments.

The above and other exemplary features, aspects, and advantages of the present invention will be more apparent from the following detailed description taken in conjunction with the accompanying drawings, in which:

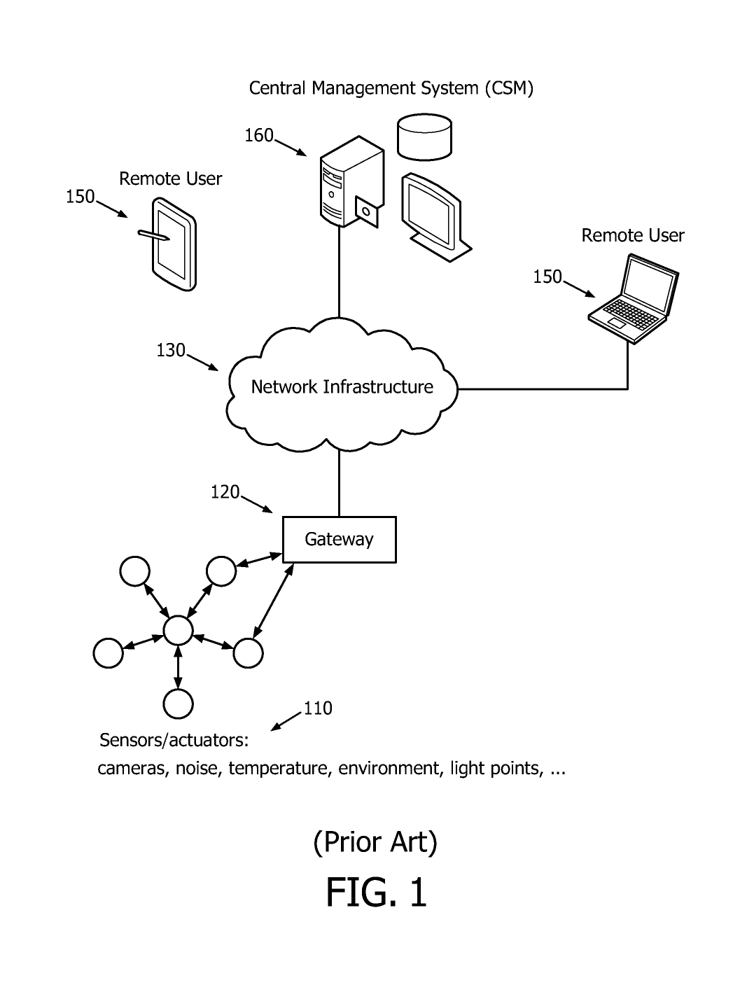

FIG. 1 illustrates a conventional Wireless Sensor and Actuator Network Architecture;

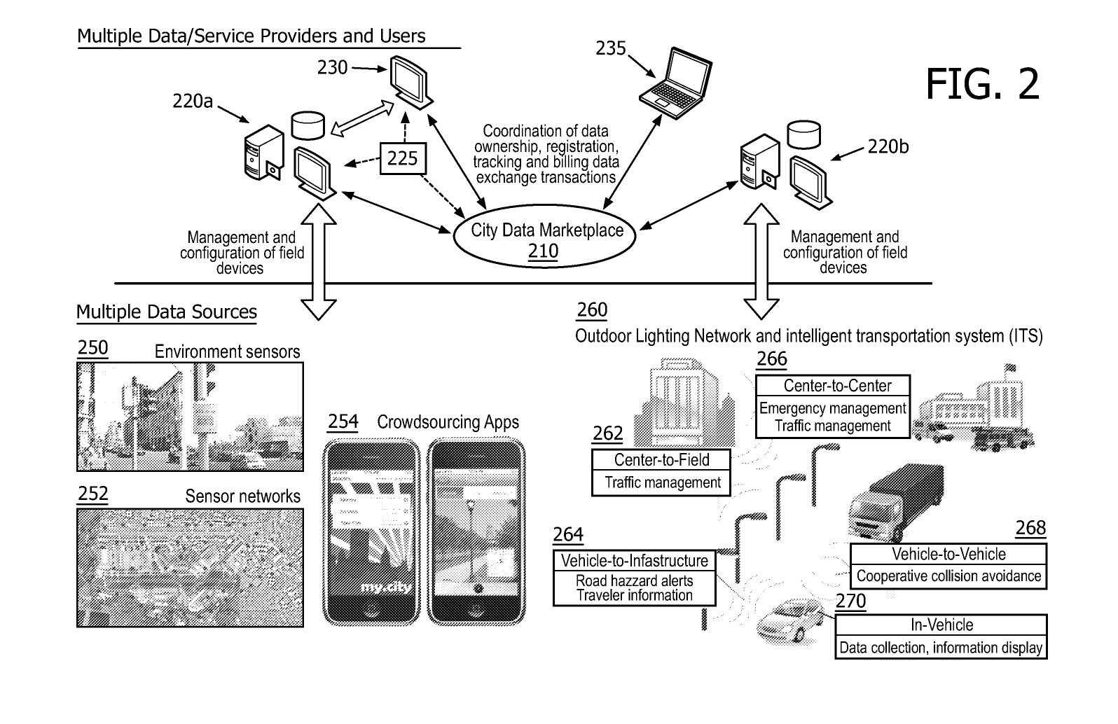

FIG. 2 illustrates various components of an embodiment of the invention and the flow of information between them;

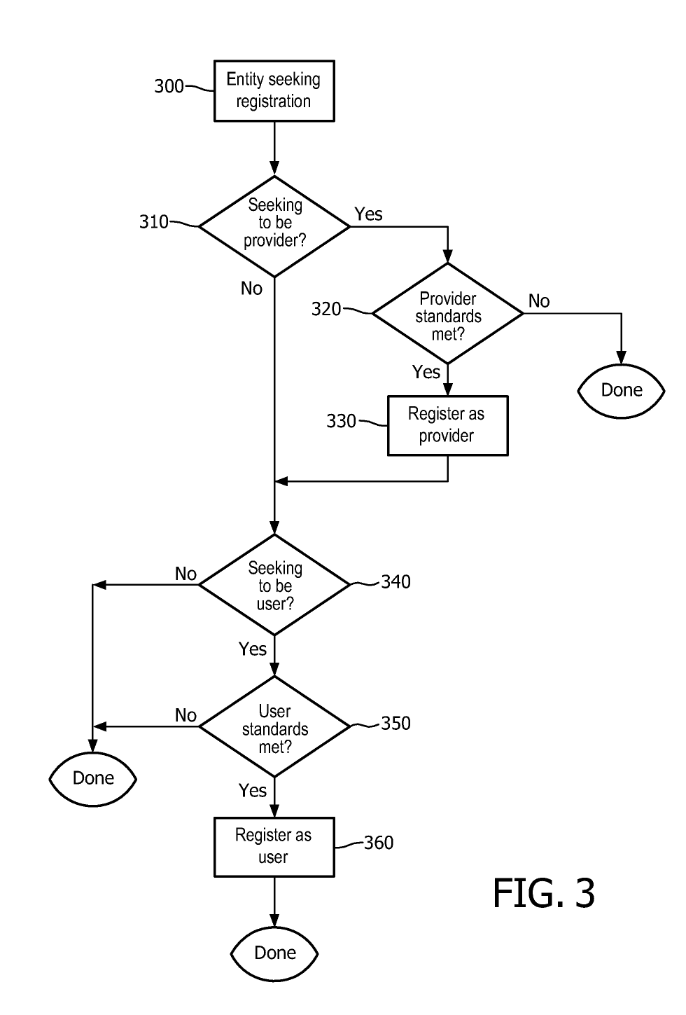

FIG. 3 is a flowchart depicting the registration process of data providers and data users according to one embodiment of the invention.

It is to be understood that these drawings are solely for purposes of illustrating the concepts of the invention and are not intended as a definition of the limits of the invention. It will be appreciated that the same reference numerals, possibly supplemented with reference characters, where appropriate, have been used throughout to identify corresponding parts.

FIG. 1 illustrates a conventional Wireless Sensor and Actuator Network (WSAN). It should be noted that the invention is not so limited, as other types of networks employing remote sensors (wireless or otherwise) are contemplated by the invention. As depicted in FIG. 1, a plurality of sensors 110 communicate through a Gateway 120 in a Network Infrastructure 130 (for simplicity, only one gateway is depicted although typically such a network comprises a plurality of such gateways). The network infrastructure is administered by a Central Management System 160 and is accessible by one or more remote users 140 and 150. As noted above, such networks are usually deployed for a specific purpose, with its own infrastructure to collect, process and present data to the target application and users.

FIG. 2 illustrates an embodiment of the invention depicting a City Data Marketplace architecture. This architecture enables a platform to share, exchange and commercialize data in an urban environment. Data may be generated by multiple devices, including, but not limited to, environment sensors 250, vehicles 268 and 270, lighting infrastructure 252, mobile devices 254, etc. For each of items 262, 266, 268 and 270 FIG. 2 provides a table in which the first entry lists examples of applicable communication modes, the middle entry lists the representative standard(s) for such a communication mode, and the last entry provides one or more representative applications.

In operation, the data sources must be associated with a service provider or user, so that ownership of data can be assigned to that entity or user. For instance, data from an outdoor lighting network (OLN) 252 can be associated to the lighting service provider who owns/manages the OLN. Data from a mobile application 254 can be associated with the device user. In addition, where mobile devices are owned by a private or government entity and used by its workers (e.g., FedEx drivers, couriers, sanitation workers, etc.), the data can be associated with that entity. Similarly, data from “non-mobile” environment sensors 250 may be associated with the government or private entity who manages the corresponding network of sensors.

Further, in various embodiments, the data received from the various devices is organized into sets. These data sets are then combined to generate new information that would not be available otherwise. By having access to multiple data sets from different providers, the city marketplace platform can generate new information by correlating data sets to find new insights. For instance, by correlating a data set about where traffic accidents happen (e.g. from an public safety or law enforcement agency) with a data set about locations of traffic/roadside signals (provided the city department of public works or department of transportation), the city market place could generate a new data set consisting of areas of high priorities for traffic/roadside signals maintenance and/or upgrades. In another example, the traffic accident data set could be combined with the lighting infrastructure data to generate a new data set of areas with low quality lighting with higher probability of traffic accidents. The combination of data sets can provide insights that may seem counterintuitive.

In order to combine data sets, various embodiments of the invention could provide a capability to scan a list of data sets available, select data sets for combination, and determine what operation to execute on such data sets.

By way of example, assume a city owns the lighting asset data (including the lamp type, wattage information, installation date), the lighting operator (e.g. utility) owns the operational data of the luminaires (such as dimming schedule, burning hours, maintenance information), and a lighting design company may own the actual illumination measurement data across a given area (lux value, geo-location and timestamp of each measurement points). All parties can be data providers to the city marketplace, which will be able to present the available data sets to prospect customers. In this example, the city could be the customer of a new data set that combines the lighting asset, operation and measurement data and outputs the set of areas where illumination does not meet standard recommendations. This new information may be used to verify compliance with safety regulation, plan retrofits and prioritize areas for investments. The city market place of the current invention can generate the new illumination data set by comparing the asset and operational data to determine desired illumination performance of an area and compare expected illumination with actual measurements. In this manner it could identify what areas fail to meet certain threshold parameters that are associated with good illumination conditions.

The users of the City Data Marketplace 210 can be service providers (e.g., 220a and 220b) who manage systems and devices deployed in the field or individual users who manage their own devices. As depicted in FIG. 2, the users may provide and/or use data through the City Data Marketplace platform.

For a user to participate in the City Data Marketplace 210 (as either a data provider or a user), he must first register onto the system. The registration process includes assignment of a unique identification to the users and set up of his roles and capabilities within the system. For instance, some users may be registered only as data providers, as others may be registered as both providers and data users. Still further, some users may seek to register as only data users (e.g., a potential retail establishment assessing auto/pedestrian traffic patterns).

FIG. 3 is a flowchart illustrating an exemplary registration process. For users seeking registration as data providers (step 310), an optional step 320 may be provided where the user's potential competence in providing reliable and accurate data may be assessed. This may entail the quality of the sensor system to be employed, the viability of the business seeking registration, and even the integrity and/or credit worthiness of the principals of that business. While this step is illustrated in the initial registration process, it is also contemplated that the invention would include a quality control component whereby inaccurate data and/or persistent data outages would be monitored and where appropriate, result in disqualification of the corresponding provider from the system. In this manner the system can attempt to ensure the integrity of the data provided to the users.

At step 330 registration of the provider occurs whereby the system will assign data identification and verification information so that generated data by the provider can become available to other users through the platform. The identification information shall uniquely identify any data provided by the owner when it is shared/exchanged through the system. Such identification is also used to track the data as it flows from one system to another. Optionally, such identification may include device and format information should it be necessary to convert the provided data into a format useable by others in the system.

In the embodiment depicted in FIG. 3, a registration process is also employed for entities seeking to be potential users of the system 340. This registration process is depicted as containing an optional step of assessing whether the entity meets eligibility standards 350. These standards may include a coarse screening of financial worthiness to ensure that the entity can pay for data later provided by the system. As in the case of providers, the invention contemplates subsequent monitoring of entities (e.g., complaints by providers) and removal of offending entities from the system if warranted.

The City Data Marketplace provides a mechanism for users to negotiate and agree on the exchange of data. The negotiation may include format, quality requirements, and economic/billing metrics, which are associated with a service level agreement (SLA) between the data source and destination that is provided by the platform. The SLA will determine the conditions for the data exchange transaction between users/systems.

Data exchange transactions are tracked in the City Data Marketplace platform. Every transaction is uniquely identified and billing information is generated based on agreed SLAs between source and destination.

Returning to the embodiment depicted in FIG. 2, exemplary flows of information will now be discussed. As illustrated, a service provider 220A, which manages a network of environment sensors can register as a data provider. User 230 may be a government agency that is responsible for air quality related safety and regulations, and registers in the platform as a data user. In this example, User 230 finds data of interest (from service provider 220a) that is available on the City Data Marketplace 210 platform and starts the process to obtain the data from service provider 220a. In one embodiment User 230 is not required to contact service provider 220a directly, as all the steps are handled by the City Data Marketplace platform. Such steps may include acceptance of data sharing conditions provided by the source (e.g. any privacy related issues) and agreement on the billing parameters and process.

Once the configuration information for the exchange is completed, the source and destination can start the data exchange transaction(s). In one embodiment of the invention, data supplied by service provider 220a is stored upon one or more storage devices associated with (but not necessarily co-located with) the City Data Marketplace 210 site. In this manner, historic data is made available for other potential Users as well as to User 230 should he desire such additional past data. In alternative embodiments, one or more service providers may create their own databases containing past data and provide this as a service in addition to providing real-time data.

In additional embodiments of the invention, the actual data may flow from the source to the destination directly, without necessarily going through the City Data Marketplace platform. Irrespective of the manner of providing the data, both the source and destination are required to exchange billing related information with the platform to enable tracking of the data exchanged. A transaction may be open for a certain period during which the data is exchanged. The period may be configured depending on the type, amount, and usage of the data exchanged. Finally, once a transaction is completed and acknowledged by both end points (source and destination), the platform will generate a billing statement and process the required financial information to provide the agreed upon economic benefits to the corresponding owner(s) of the data exchanged. Alternatively, should the period of requested data be for an extended period of time, a billing statement can be provided on an agreed upon periodic basis (e.g., weekly or monthly).

In another embodiment illustrated in FIG. 2, an optional third User 225 may be situated between User 230 and Service Provider 220a. Such a user 225 is available to provide a data clean/transformation service to both parties to make sure the exchanged data is understandable, since the two end points in the transaction may use different proprietary information systems and different data format thereof. User 225 could register its data transformation service plugin/tool (which translates the data flowing between 220a and 230 back and forth) on the platform. As a result, User 225 could also claim a certain value from the transaction for the service provided on the City Data Marketplace platform.

In additional embodiments where data flows through the City Data Marketplace 210, such a transformation service can be provided by the City Data Marketplace itself, which could then impose a fee for this service. In addition to the fee for this service, further embodiments of the invention contemplate various means to compensate the City Data Marketplace for its provided services. These types of compensation include, but are not limited to, an administration fee to cover the assessment/certification of a user to join the system, fees for users based upon usage of the data, and a percentage charge (or flat fee) to a user and/or to a provider based upon the billing statement value of the data provided to the user.

Although not illustrated in FIG. 2, it is contemplated that the City Data Marketplace 210 comprises one or more processors executing computer software as well as memory devices to perform the functions discussed above. In addition, various administrative functions are optionally included within this system. These may include providing capabilities for updating system software, and hardware, testing of equipment and interfaces, and communications with users that may not be directly related to data flow and/or billing. These additional communications may include alerts as to system downtime for repairs and/or maintenance. They may also various types of advertisements or notices related to entities available on the system for providing and/or obtaining types of data. Thus by way of example, once a new User registers onto the system, he could be advised of types of available provider data that he may find of use. In further embodiments entities would be permitted to query the system to thereby search for specific types of available data.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., serial, parallel, ISA bus, microchannel bus, PCI bus, PCMCIA bus, USB, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated. For example, any numerical values presented herein are considered only exemplary and are presented to provide examples of the subject matter claimed as the invention. Hence, the invention, as recited in the appended claims, is not limited by the numerical examples provided herein.

What is claimed is:

1. A method for commercializing sensor data obtained by a plurality of devices in an environment, wherein the plurality of devices include one or more groups of devices that correspond to respective networks, each network having a particular infrastructure to collect and process sensor data for a particular network application, the method comprising:
receiving sensor data obtained from one or more of the devices, wherein the devices are a sensor or comprise a sensor;
assigning the sensor data from the one or more devices to one or more data sets, wherein the data sets correspond to one or more of the networks;
associating a data provider with each of said data sets;
transforming the data sets to a predetermined or user requested data format;
providing one or more transformed data sets to a user; and,
compensating the data provider of the transformed data sets for its use.

2. The method of claim 1 further comprising registering entities as data providers.

3. The method of claim 2 wherein said providing step comprises enabling one or more data sets to be communicated directly from a provider to a user.

4. The method of claim 2 wherein said registering step comprises associating one or more of the devices with each registered entity.

5. The method of claim 4 wherein the devices are selected from the group consisting of environmental sensors, sensor networks, crowdsourcing applications, devices employed in outdoor lighting networks, devices employed in intelligent transportation systems, and combinations thereof.

6. The method of claim 1 further comprising tracking usage of each data set across applications and services.

7. The method of claim 1 wherein said compensating step comprises enabling tracking of usage of one or more data sets by one or more users.

8. The method of claim 1 wherein said compensating step comprises assigning a value to the data.

9. The method of claim 8 wherein said assigned value is negotiated between the data provider and the user of the data set.

10. The method of claim 8 wherein said assigned value is at least in part determined by a centralized server.

11. The method of claim 1 wherein said providing step comprises transforming the data into a format required by the user.

12. The method of claim 1 further comprising assessing the quality of the data set.

13. A system for commercialization sensor data obtained by a plurality of devices in an environment, wherein the plurality of devices include one or more groups of devices that correspond to respective networks, each network having a particular infrastructure to collect and process sensor data for a particular network application, the system comprising:
a centralized server; and,
a communication means for communicating data from said devices to the centralized server;
wherein the centralized server comprises:
means for receiving sensor data obtained from one or more of the devices, wherein the devices are a sensor or comprise a sensor;
means for assigning the sensor data from the one or more devices to one or more data sets, wherein the data sets correspond to one or more of the networks;
means for associating a data provider with each of said data sets;
means for transforming the data sets to a predetermined or user requested data format;
means for providing one or more data sets to a user; and
means for compensating the data provider of said at least one data set for its use.

14. The system of claim 13 wherein said at least one device is a sensor component of a Wireless Sensor and Actuator Network (WSAN).

15. The system of claim 13 wherein said at least one device is selected from the group consisting of environmental sensors, sensor networks, crowdsourcing applications, devices employed in outdoor lighting networks, devices employed in intelligent transportation systems, and combinations thereof.

16. The system of claim 13 wherein said centralized server further comprises means for associating one or more devices with a data provider.

17. The system of claim 13 wherein said centralized server further comprises means for tracking usage of one or more data sets.

18. The system of claim 13 wherein said centralized server further comprises means for assigning a value to the data.

19. The system of claim 13 wherein said means for providing comprises a communication means for transmitting said one or more data sets from said central server to said user.

20. The system of claim 13 wherein said means for providing comprises a means for enabling one or more data sets to be communicated directly from a provider to a user.

21. The method of claim 1 wherein said assigning step comprises deriving a data set by combining sensor data obtained from at least two networks.

22. The system of claim 13 wherein said means for assigning step comprises deriving a data set by combining sensor data obtained from at least two networks.
